(19) United States
(12) Patent Application Publication
(10) Pub. No.: US 2013/0290202 A1
(43) Pub. Date: Oct. 31, 2013

(54) SYSTEM AND METHOD FOR MANAGING COMMUNICATIONS ON A SOCIAL NETWORK

(71) Applicants: Melvin C. Nunnery, Oxnard, CA (US); Jose Villasenior, Oxnard, CA (US); Alfred Jones, Oxnard, CA (US); Gerrick Hewitt, Camarillo, CA (US)

(72) Inventors: Melvin C. Nunnery, Oxnard, CA (US); Jose Villasenior, Oxnard, CA (US); Alfred Jones, Oxnard, CA (US); Gerrick Hewitt, Camarillo, CA (US)

(73) Assignee: SchollyME, LLC, Camarillo, CA (US)

(21) Appl. No.: 13/440,098

(22) Filed: Apr. 25, 2012

(51) Int. Cl. G06Q 99/00

(52) U.S. Cl. 705/319

(57) ABSTRACT

A system for managing communications on a social network is provided. A profile management module manages a set of user profiles. Individual user profiles in the set of user profiles are respectively associated with a set of sports profiles. A compliance management module flags one of the user profiles in the set of user profiles in response to receipt of a flag request. The compliance management module sends a communication transmitted to or transmitted from the user profile in response to a determination that the user profile is flagged when the communication is transmitted.

### FIELD OF THE INVENTION

The field of the invention relates to social networks and in particular to managing communications on a social network.

### BACKGROUND

The popularity of social networking services continues to increase. Social networking services provide an online platform that allows users to establish relationships, communicate electronically, and share media including photos, videos, and music. Examples of popular social networking services include MySpace, Facebook, Twitter, Google+, LinkedIn, and the like.

Social networking services have opened the door to new opportunities for communication and sharing information. As a result social networking services have impacted the way people initiate and maintain personal and professional relationships. For example collegiate athletic programs may utilize social networking services as athletic recruiting tools. Rules and guidelines, however, may govern direct communications between, for example, coaches and prospective student-athletes. The National Collegiate Athletic Association (NCAA), for example, has set forth rules indicating what types of social networking communications are and are not permissible. Violations of these rules can result in penalties for collegiate athletic programs.

Therefore a need exists for a system and method that provides social networking services compatible with rules governing athletic recruiting activities.

### SUMMARY

A system for managing communications on a social network is provided. A profile management module manages a set of user profiles. Individual user profiles in the set of user profiles are respectively associated with a set of sports profiles. A compliance management module flags one of the user profiles in the set of user profiles in response to receipt of a flag request. The compliance management module sends a communication transmitted to or transmitted from the user profile in response to a determination that the user profile is flagged when the communication is transmitted.

A computer-implemented method of managing communications on a social network is also provided. A set of electronic user profiles is maintained. Individual user profiles in the set of user profiles are respectively associated with a set of electronic sports profiles. In response to receipt of a flag request, one of the user profiles in the set of user profiles is flagged. When a communication is transmitted to or transmitted from the user profile, the communication is sent to a compliance entity in response to a determination that the user profile is flagged.

A computer-implemented method of monitoring communications on a social network is further provided. It is determined whether a first user profile in a set of user profiles of a sports-themed social network has transmitted a communication to a second user profile in the set of user profiles. It is also determined whether the first user profile or the second user profile is flagged. The communication is sent to a compliance entity in response to a determination that at least one of the first user profile or the second user profile is flagged.

### BRIEF DESCRIPTION OF THE DRAWINGS

FIG. 1 is an example of an implementation for managing communications on a social network.

FIG. 2 is an example of an implementation of an interface portal displaying a user profile.

FIG. 3 is an example of an implementation of an interface portal displaying private information associated with the user profile of FIG. 2.

FIG. 4 is an example of an implementation of an interface portal displaying a public message board.

FIG. 5 is an example of an implementation of an interface portal displaying a list of private messages.

FIG. 6 is a flowchart of example method steps for establishing an association between users.

FIG. 7 is an example of an implementation of an interface portal displaying video items uploaded by a player.

FIG. 8 is a flowchart of example method steps for managing a transcript request.

FIG. 9 is a flowchart of example method steps for verifying academic information associated with a player.

FIG. 10 is a flowchart of example method steps for tracking a player.

FIG. 11 is a flowchart of example method steps for managing a visitation request.

FIG. 12 is a flowchart of example method steps for sharing a video item with a coach.

FIG. 13 is a flowchart of example method steps for sharing a video item with a set of players.

FIG. 14 is an example of an implementation of an interface portal displaying video items to share.

FIG. 15 is an example of an implementation of an interface portal displaying a shared video item.

FIG. 16 is a flowchart of example method steps for managing communications of a social networking system.

### DETAILED DESCRIPTION

A system and method for managing communications in a sports-themed social network are provided. The sports-themed social network, in this example, may allow sports players, coaches, and fans to establish relationships in order to share personal information and sports information. As discussed further below, the sports-themed social networking system manages communications between users of the system in order to provide social networking services compatible with rules governing athletic recruiting activities.

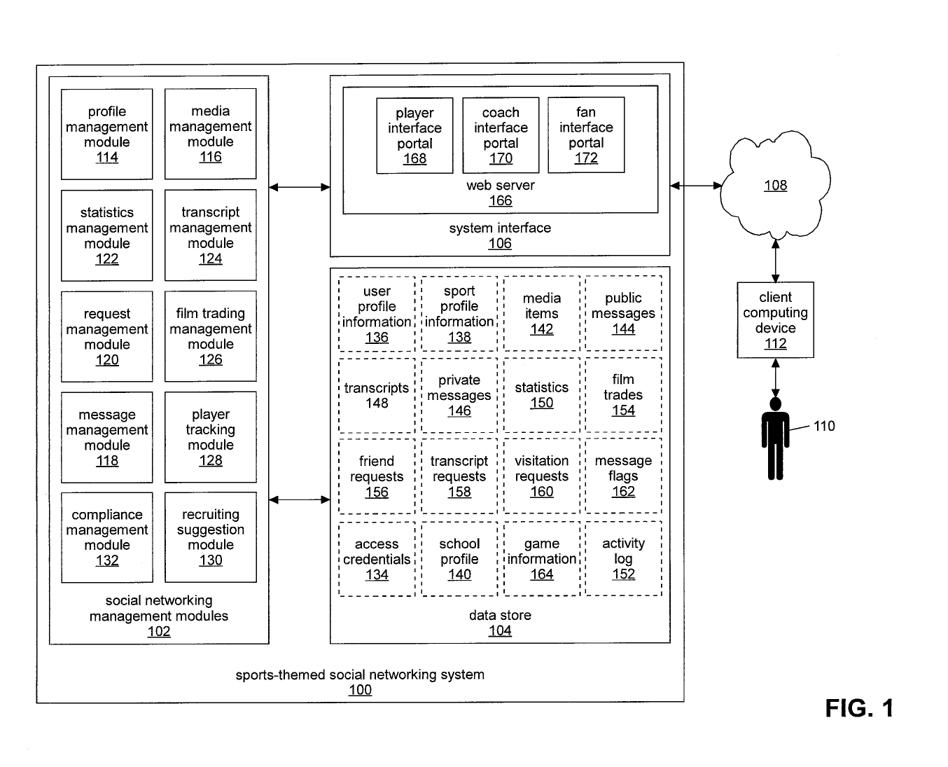

Referring to FIG. 1, an example of an implementation of a system 100 for managing communications on a social network is shown (“social networking system”). The social network, in this example, is a sports-themed social network. The social networking system 100, in this example, includes: a set of social networking modules 102 that provide personal social networking services, sports-related social networking services, and recruiting-related social networking services; a data store 104 that stores personal information, sports information, and academic information; and a system interface 106 that provides access to the system via a network 108. A user 110 may use a client computing device 112 to access the system 100 via the network 108 and system interface 106.

Personal social networking services include: creating a user profile; uploading personal information to be associated with the user profile; associating the user profile with other user profiles; uploading media items (e.g., picture media items, video media items, music media items, and documents) and associating the media items with the user profile; and sending messages (i.e., electronic communications) to other user profiles. Sports-related social networking services include: creating sports profiles and associating the sports profiles with the user profile; uploading sports information (e.g., team names, playing positions, and statistics) and respectively associating the sports information with the sports profiles; and selecting media items for presentation as sports highlights. Recruiting-related social networking activities include: uploading, verifying, and requesting transcripts; sharing and viewing video media items (i.e., “film trading”); monitoring user profiles in order to follow the respective social networking activities of users; requesting recruiting visitations; automatically determining recruiting suggestions based on transcript requests; and flagging and monitoring communications between users that may violate recruiting rules and guidelines. The personal, sports-related, and recruiting-related social networking activities may include additional or alternative social networking activities.

To provide personal social networking services, the social networking system 100, in this example, includes: a profile management module 114; a media management module 116; a message management module 118; and a request management module 120. To provide sports-related social networking services, the social networking system 100, in this example, includes a statistics management module 122. The profile management module 114 and media management module 116 may also provide sports-related social networking services. To provide recruiting-related social networking services, the social networking system 100, in this example, includes: a transcript management module 124, a film trading management module 126, a player tracking module 128, a recruiting suggestion module 130, and a compliance management module 132. The request management module 120 and transcript management module 124 may also provide recruiting-related social networking activities. The sports-themed social networking system 100 may include additional or alternative modules in order to provide personal, sports-related, and recruiting-related social networking activities.

The set of social networking modules 102 may reside at a single computing device such as, for example, an application server or may be distributed such that the social networking modules respectively reside at multiple computing devices in signal communication with each other, e.g., multiple interconnected application servers.

The data store 104 may store personal information, sports information, and academic information. The data store of the sports-themed social networking system 100, in this example, includes: access credentials 134; user profile information 136; sport profile information 138; school profile information 140; media items 142 (e.g., pictures, videos, and music); public messages 144 (i.e., message posts) and private messages 146; transcripts 148 (i.e., documents); game information and statistics 150; activity logs 152; film trades 154; various types of requests including friend requests 156, transcript requests 158, and visitation requests 160; message flags 162; and game information 164. It will be understood that the types of information listed and shown in FIG. 1 is by way of example only and that additional or alternative types of information and data may be stored in the data store 104 of the sports-themed social networking system 100.

The data store 104 may be, for example, a database managed by a database management system (not shown). The data store 104 may store the personal, sports-related, and academic information as, for example, a set of related records with respective associated fields.

A user 110 may access the personal, sports-related, and academic information stored in the data store 104 via the system interface 106. The system interface 106 may include a set of interface portals that include user input elements configured to receive user input from the user when interacting with the system. User input elements may include, for example, buttons, menus, checkboxes, combo boxes, drop-down lists, list boxes, radio buttons, scrollbars, sliders, text boxes, and other types of user interface elements. A user 110 may use a client computing device 112 to access the system 100 via the system interface 106 over a network 108 such as, for example, a packet-based network (e.g., the Internet) or a cellular network. The client computing device 112 may be, for example, a desktop computer, laptop computer, tablet computer, palmtop computer, mobile telephone, video game console, “smart” television, and other network-enabled computing devices.

The system interface 106 of the sports-based social networking system 100, in this example, includes a web server 166 that presents one or more interface portals to the client computing device 112. The web server 166 may present a particular interface portal based on the type of user accessing the system 100. As discussed further below, user types may include, for example, players, coaches, fans, and administrators. Accordingly the web server 166 of the system interface 106, in this example, may present a player interface portal 168 to player-type users, a coach interface portal 170 to coach-type users, a fan interface portal 172 to fan-type users, and an administration portal (not shown) to administrator-type users. The interface portals may be, for example, web pages. Also discussed further below, a particular interface portal may allow or deny access to particular information stored at the data store 104 based on the user type of the user accessing the social networking system 100.

In this way, the sports-themed social networking system 100 advantageously provides social networking services compatible with athletic recruiting rules and guidelines. Players may advantageously share sports information in an online social environment in order to attract the attention of coaches looking for potential recruits. Additionally coaches may advantageously browse player profiles to identify players for subsequent recruiting efforts. Moreover the sports-themed social networking system 100 can advantageously flag and monitor communications between players and coaches.

Users accessing the sports-themed social networking system 100 may be associated with a user type. As mentioned above, user types may include, for example players, coaches, fans, and administrators. Users may register with the social networking system 100 in order to gain access to the social networking system 100. Upon registration a user may provide or may be provided with access credentials (e.g., a username and password) that the user may use to access the system 100. Accordingly the social networking system 100 may include an authentication module (not shown) that authenticates users attempting to access the system by verifying a user has provided valid access credentials. Upon authentication, the web server 166 of the system interface 106, in this example, may present an interface portal to the user based on the user type associated with the user.

### 1.1 Players

Different types of user may engage in different types of activities in the sports-themed social networking system 100 in this example. Players, for example, may engage in personal social networking activities, sports-related social networking activities, and recruiting-related social networking activities. A player may create a personal user profiles and upload personal information associated with the user profile. A player may also create one or more sport profiles (i.e., a set of sport profiles) and the sport profiles may be respectively associated with the user profile for the player. If the player plays multiple sports, the player may create multiple sport profiles that are respectively associated with the user profile for the player. If the player plays baseball, basketball, and football, for example, the player may create a baseball sport profile, a basketball sport profile, and a football sport profile, which may each be associated with the user profile for the player. A player may also upload academic information relevant to athletic recruiting activities, and the academic information may also be associated with the user profile for the player.

The profile management module 114 may receive the user profile information 136 and sports profile information 138 as user input from the client computing device 112 and store the user profile information and sports profile information in the data store 104. The profile management module 114 may also associate the user profile information 136 with the user profile for the player and associate the sports profile information 138 with the respective sport profiles for the player. Additionally the profile management module 114 may associate the academic information with the user profile for the player. In this example, the profile management module 114 may create user profile records and sport profile records at the data store 104. The profile management module 114 may respectively store the user profile information 136 in the user profile records or otherwise respectively associate the user profile information with the user profile records. The profile management module 114 may also respectively store the sport profile information 138 in the sport profile records or otherwise respectively associate the sport profile information with the sport profile records. It will be understood that additional or alternative approaches may be selectively employed to carry out profile-related activities.

Personal information may include, for example: name; home address; home telephone number; mobile telephone number; email address; date of birth; height; weight; favorite food; favorite pastime; and a description about the player. The player may additionally or alternatively provide the description as a video clip (e.g., 1 minute and 23 seconds). Users may initiate playback of the video clip by selecting the video clip in the player profile. Personal information may include, for example: names of the parents of the player; mobile telephone numbers for parents; and email addresses for the parents. Sports information may include, for example: sport type (e.g., baseball, basketball, football, etc.); school name; school mascot; school level (e.g., high school, college, professional, etc.); grade level (e.g., senior, junior, sophomore, freshman, etc.); and play level (e.g., varsity, junior varsity, etc.). Sports information may also include the name of the school the player desires to attend and whether the player has committed or signed with that school. Sports information may further include a sports schedule for the player, which lists the times, dates, locations, and results (i.e., W—win, L—loss, and final score) of games for a sports season. A player may provide the times, dates, locations and results of the games, and the sports schedule information may be stored at the data store and associated with the player profile for the player. The system, in this example, may be configured to automatically update the result of a scheduled game for all players associated with a school once at least one of the players associated with the school provides a result for the game. Academic information may include, for example, grade point average (GPA); standardized test scores (e.g., SAT scores, ACT scores, etc.); and transcripts. Players may upload copies of their transcripts to the social networking system as discussed further below. Access to certain items of information associated with a user profile and a sports profile may be restricted based on user types also discussed further below.

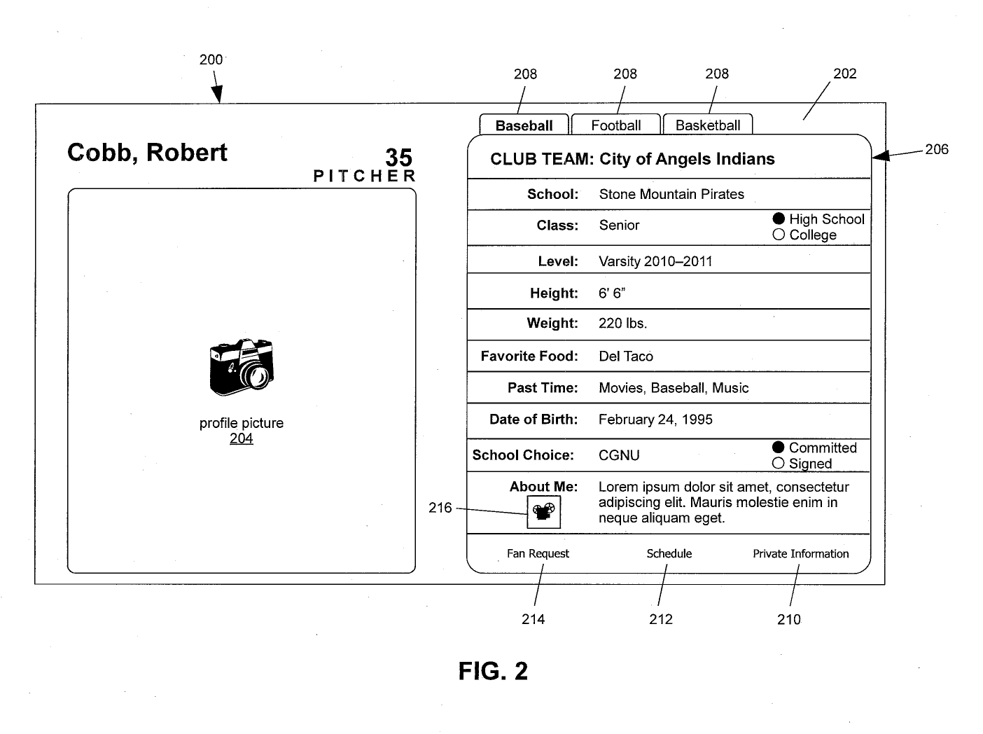

Referring to FIG. 2, an example of an interface portal 200 displaying an example of a user profile 202 for a player is shown. The interface portal 200, in this example, displays a profile picture 204 for the player next to a set 206 of personal information and sports information for the player. The interface portal 200, in this example, also includes tabs 208 for displaying sports information for the various sport profiles associated with the user profile for the player. The interface portal, in this example, also includes a button 210 for displaying private information associated with the player, a button 212 for displaying the sports schedule for the player, a button for initiating a fan request for the player, and a button for initiating playback of a video description for the player.

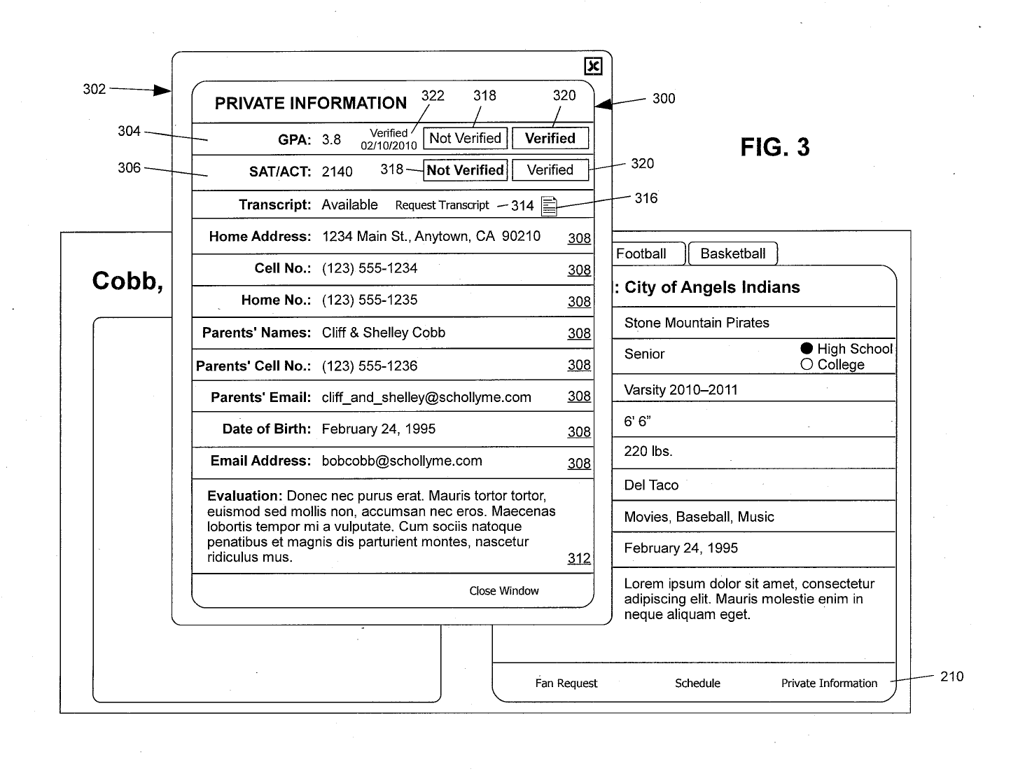

Referring to FIG. 3, a user with access to the private information may select the button 210 to display the private information 300 associated with the player. As seen in FIG. 3, the private information 300 may be displayed, for example, in a popup window 302. The private information 300, in this example, includes information relating to the grades 304 and standardized test scores 306 for the player. The private information 300, in this example, also includes contact information 308 for the player as well as the parents 310 of the player. The private information 300 may also include a player evaluation 312 for the player. Administrators (discussed below) may review footage of the player and provide the system 100 with the player evaluation 312 for the player, which may include, for example, the strengths, weaknesses, and areas of improvement for the player. The player evaluation 312 may be stored at the data store 104 and associated with the player profile for the player.

A player may also upload various media items 142 for storage at the data store 104 of the sports-themed social networking system 100. Media items 142 may be, for example, picture items, video items, music items, and document items. A picture item may be an image file corresponding to an image file formats such as, for example, JPEG (Joint Photographic Experts Group), PNG (Portable Networks Graphics), GIF (Graphics Interchange Format), and the like. A player may select a picture item as the representative picture 204 of the user profile for the player, i.e., the profile picture. A video item may be a video file corresponding to a video file format such as, for example, AVI (Audio Video Interleave), MPEG (Moving Picture Experts Group), and the like. Video items, in this example, may correspond to game footage and highlight footage of sporting events a player participated in. As discussed further below, a player may select a set of game footage and a set of highlight footage for presentation at the user profile of the player. A music item may be an audio file corresponding to an audio file format such as, for example, AAC (Advanced Audio Coding), MP3 (MPEG Layer III Audio), WMA (Windows Media Audio), and the like. The interface portals of the social networking system 100, in this example, may include a music player to initiate playback of a selected music item as well as a link to an online retailer where the selected music item may be purchased and downloaded. A document item may be a document file corresponding to a document file format such as, for example, PDF (Portable Document Format), PS (PostScript), and the like. A player may upload one or more school transcripts 148 as document items, which may be viewed during recruiting activities as discussed further below.

The media management module 116 may manage the uploading of media items 142 to the sports-themed social networking system 100. The media management module 116 may create a new media item record at the data store 104 and associate the new media item record with the uploaded media item 142. The media management module 116 may associate the new media record with the uploaded media item 142 using, for example, the file path of the uploaded media item at the data store 104. The media management module 116 may store the file path for the uploaded media item 142 in the new media item record or otherwise associate the file path for the uploaded media item with the new media record.

A player interface portal 168 may also include a customizable user interface element (not shown) that has the appearance of an athletic sports locker. A player may customize the locker user interface element by uploading various media files (e.g., audio files) for presentation in the locker. For example, when a player clicks the locker interface element, a set of slots (e.g., 23 slots) may be displayed, and a user may select, e.g., a slot and a song for presentation in the slot of the locker user interface element. Upon selection of the slot and the song, in this example, the song may be uploaded to the data store of the system for storage. The player may then initiate playback of the song by selecting it in the slot of the locker user interface element. It will be understood that the locker user interface element may be included in the profile interface portals of other types of users (e.g., coaches and fans) as well.

A player may also establish a relationship or association with another player having a user profile on the sports-themed social networking system 100. A player may submit a request (i.e., “friend request”) to associate the user profile for the player with the user profile for another player. The request management module 120 may manage the friend request procedure as discussed further below. Once a player has established an association with another player, the players may be referred to as “teammates” within the context of the sports-themed social networking system 100.

Teammates may use the social networking system 100 to exchange public messages 144 and private messages 146. Public messages 144 may be referred to as “message postings” or “posts” within the context of the sports-themed social networking system 100. Posts may be displayed at the user profile for a player and displayed to all types of users. The message management module 118 may associate posts with a user profile in general or may be associated with a particular media item 142 uploaded by the player. For example, teammates may submit posts for display at a public message board of the user profile or in response to a video item uploaded by a player. Accordingly, posts may be associated with the user profile for the player or associated with a media item 142 uploaded by the player. Private messages 146 may only be visible to the sender and recipient of the private message. A player may reply to a private message 146 with another private message. A player may also, for example, forward, delete, or archive private messages 146.

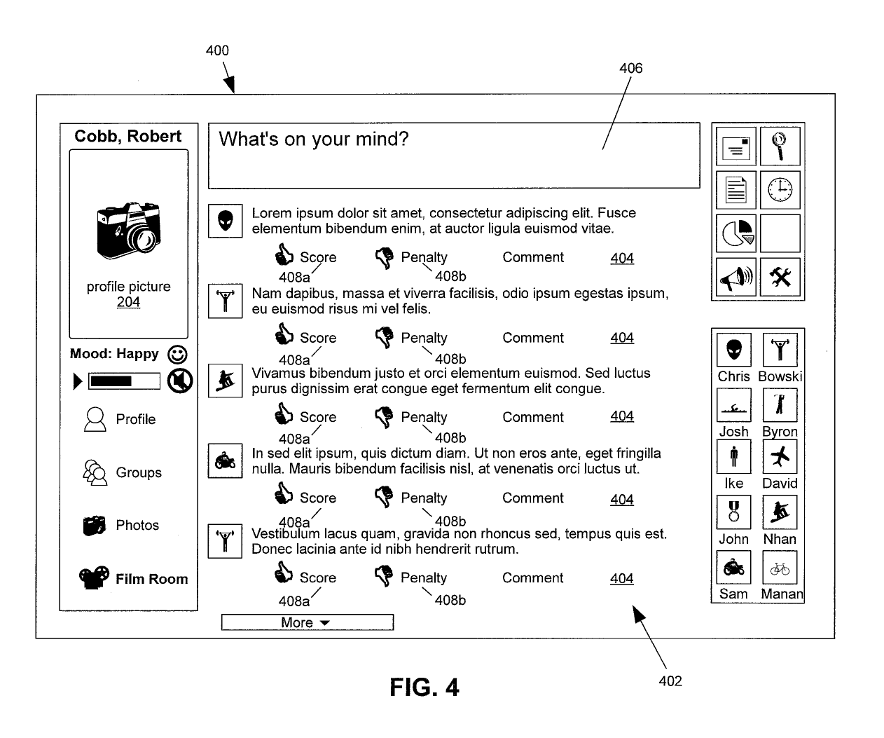

Referring to FIG. 4, an example of an implementation of an interface portal 400 displaying a public message board 402 is shown. As seen in FIG. 4, a list of posts 404 associated with a user profile is displayed. The interface portal 400, in this example, also includes a message entry component 406 for posting messages to the user profile. Each post 404, in this example, includes user interface controls 408a and 408b for submitting a rating of the post, e.g., like or dislike (“score” or “penalty”). Post ratings may be stored in the data store 104 as rating records and associated with the message record for the post 404.

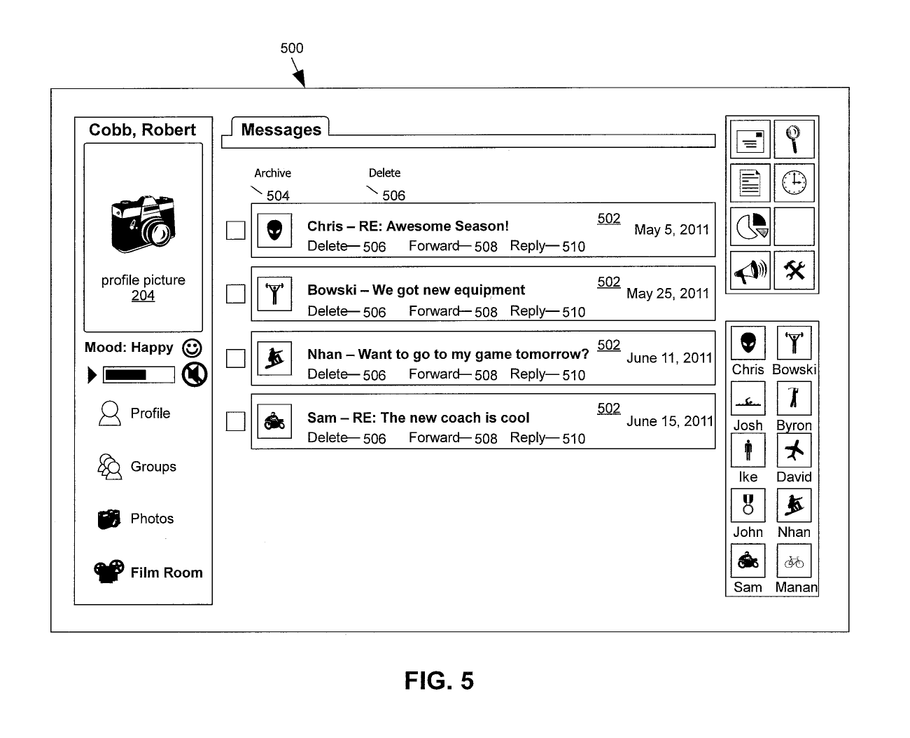

Referring to FIG. 5, an example of an implementation of an interface portal 500 displaying a list of private messages 502 is shown. As seen in FIG. 5, a list of private messages 502 sent to a user is displayed. The interface portal 500, in this example, includes user interface controls 504, 506, 508, 510 for respectively archiving, deleting, forwarding, and replying to a private message 502.

The message management module 118, in this example, may manage the exchange of public messages 144 and private messages 146 between users. When a message is sent from one teammate to another, the message management module 118, in this example, may create a message record at the data store 104. The message management module 118 may store message-related information (e.g., sender, recipient, subject, content, date sent, etc.) in a message record or otherwise associate the message-related information with the message record. When a player deletes a message, the message management module 118, in this example, may delete the message record for the message from the data store 104. It will be understood that additional or alternative approaches may be selectively employed to carry out message-related activities.

Players may also be associated with a player ranking, e.g., a maximum player ranking of 100 and a minimum player ranking of 23. The player ranking may be stored in the data store 104 as sport profile information 138 associated with the player. In one example implementation, players that have uploaded two or more full game videos may be eligible to receive a ranking. Coaches may be able to search via the coach interface portal 170 for players based on the player rankings respectively associated with the players.

As an example, a coach may search for players based on playing position (e.g., basketball point guard), and a set of search results may be returned to the coach that lists the players associated with the selected playing position. The set of search results may order the list of players according to the respective player rankings associated with the players, i.e., ascending or descending player rankings. The coach may also select via the coach interface portal 170 to display a subset of players matching the search criteria, e.g., the top 100 or top 500 players of the search results.

In this way, coaches may tailor search criteria to the types of players the coaches seek to recruit for their respective sports programs. Other examples of ways coaches may use the player ranking and player position as search criteria include: the top passing point guards, the top shooting point guards, the top defensive point guards, and so on for other positions across other sports.

A player may also be associated with an overall player ranking as well as individual statistics rankings, e.g., shooting, rebounding, etc., if a player is associated with multiple positions. As an example, a player may be associated with a shooting statistics ranking as well as a rebounding statistics ranking, and each individual statistics ranking may be different from each other as well as the overall player ranking, e.g., a shooting statistics ranking of 90, a rebounding statistics ranking of 60, and an overall player ranking of 42. Coaches may also be able to search for players on individual statistics rankings in a similar fashion as discussed above.

Coaches may also be able to search using other types of player and sports criteria including, for example: by state (e.g., all players in California, Oregon, and Washington); by gender; by height; by weight; handedness (i.e., right-handed and left-handed); and the like.

### 1.2 Fans

Another user type, in this example, is a fan. A fan may register with the system 100 and create a user profile as described above. A fan may use the sports-themed social networking system 100 to follow the online activities of players having profiles on the social networking system. Fans may associate with players such that the user profile for the fan is associated with the user profile of a player. As seen in FIG. 2, the interface portal 200 displaying a user profile 202 for a player may include a button 214 to request an association with a player (i.e., a “fan request” or “friend request”). The friend request procedure will be discussed below in further detail. In the context of the sports-themed social networking system 100, a fan may be described as “following” a player once an association between the fan and the player is established. When a fan follows a player, the fan interface portal 172, in this example, presents a list of online activities the player engages in within the social networking system 100. For example, the list of online activities may display new posts 144 submitted by the player, new media items 142 uploaded by the player, etc.

A fan may also establish an association with another fan such that the user profiles of the fan is associated with the user profile of the other fan. A fan may request an association with another fan (i.e., “friend request”) as described in further detail below. Once fans are associated with one another, fans may submit posts 144 to their respective user profiles and exchange private messages 146 as described above.

### 1.3 Administrators

The sports-themed social networking system 100, in this example, may also include an administrator user type. An administrator, in this example, may manage access to the social networking system 100 for an entity engaging in athletic recruiting activities such as, for example, a school athletic department. An administrator may create a school profile and upload school information 140 for the school profile (e.g., school name, location and address, contact information, description of athletic programs, etc.). The profile management module 114, in this example, may create a school profile record in the data store 104. The profile management module 114 may receive the school information 140 as user input and store the school information in the school profile record or otherwise associate the school information with the school profile record. It will be understood that additional or alternative approaches may be employed to provide the school profile information 140.

Administrators may also manage access to the sports-themed social networking system 100 for coaches associated with the school. Administrators may generate access credentials 134 for one or more coaches such that the coaches may access the social networking system 100. For example, when a new coach is hired, an administrator may generate a new username and password for the coach. When a coach is fired, for example, the administrator may remove the access credentials 134 for the coach such that the coach may no longer access the social networking system 100. An administrator may also assign an access level to the coaches for the school. The sports-themed social networking system 100 may use the access level for a coach to determine whether a coach has access to the personal information, sports information, or recruiting information for a player. Access levels will be discussed in further detail below.

Also discussed further below, the compliance management module 132 of the sports-themed social networking system 100, in this example, may forward flagged messages to an administrator. By forwarding flagged messages to an administrator, the sports-themed social networking system 100 advantageously allows administrators to address potential communication violations resulting from athletic recruiting activities.

### 1.4 Coaches

As mentioned above, the sports-themed social networking system 100 may include a coach user type. The coach user type, in this example, may be further divided into three sub-types based on the access level for a coach. The coach user sub-types, in this example, include: head coach, assistant coach, and graduate assistant. A head coach may have full access (i.e., level 1 access) to the personal information, sports information, and academic information for a player. For example, a head coach may have access to sensitive identification information for a player (e.g., the Social Security number for a player) as well as the transcripts 148 for a player. An assistant coach may have limited access (i.e., level 2 access) to the personal information, sports information, and academic information for a player. For example, an assistant coach may not be able to access sensitive identification information or transcripts 148 for a player, but may be able to access the contact information for a player. Graduate assistants may have restricted access (i.e., level 3 access) that does not allow the graduate assistant to access identification information, transcripts 148, or contact information, but rather the basic personal information and sports information.

A coach may create a user profile as described above. The profile management module 114 may create a user profile record for a coach at the data store 104 and receive personal information (e.g., contact information, etc.) for the coach as user input. The profile management module 114 may store the personal information in the user profile for the coach or otherwise associate the personal information with the user profile for the coach. A coach may also establish an association with another coach such that the user profile for the coach is associated with the user profile for the other coach. Once coaches are associated with one another, coaches may submit posts 144 to their respective user profiles and exchange private messages 146 as described above.

Coaches may use the sports-themed social networking system 100 to browse player profiles and the respective sports profiles for the players. In this way, coaches may identify players as targets for athletic recruiting activities. The sports-themed social networking system 100 may provide coaches access to academic information for a player (e.g., transcripts 148, GPAs, and standardized test scores). A coach may request a transcript 148 from a player as described in further detail below. The sports-themed social networking system 100, in this example, provides verification of transcripts 148, grades, and standardized test scores. As a result, the sports-themed social networking system 100 advantageously improves the efficiency of athletic recruiting activities.

Coaches may also upload media items 142 to the sports-themed social networking system 100. For example, coaches may upload video items of full game footage or highlight footage. The media management module 116 may store the uploaded media items 142 at the data store 104 and associate the media items with the user profile for a coach. As discussed further below, the sports-themed social networking system 100 allows coaches to share uploaded video items (i.e., “trade films”). The film trading management module 126, in this example, manages the sharing of upload video items between coaches.

A coach may also submit via the sports-themes social network 100 a request 160 to visit with a player (i.e., “visitation request”). As discussed further below, the request management module 120 may manage visitation requests 160.

### 2. Friend Requests

As mentioned above users of the sports-themed social networking system 100 may establish associations with other users of the social networking system such that the user profile for a user is associated with the user profile for another user. A player, in this example, may establish associations with fans, coaches, and other players. When players are associated with one another, the players may be referred to as “teammates.” A fan, in this example, may establish associations with players and other fans. Coaches, in this example, may establish associations with players and other coaches.

When a player receives a friend request 156, the player may, in this example, assign the user associated with the friend request to a group. Groups may include, for example, teammates, fans, and coaches. The system 100 may automatically assign the user to a default group until the player changes the group the user is assigned to. In this example, the user associated with a friend request 156 may be automatically assigned to the fan group by default until the player assigns the user to the teammate or coach group.

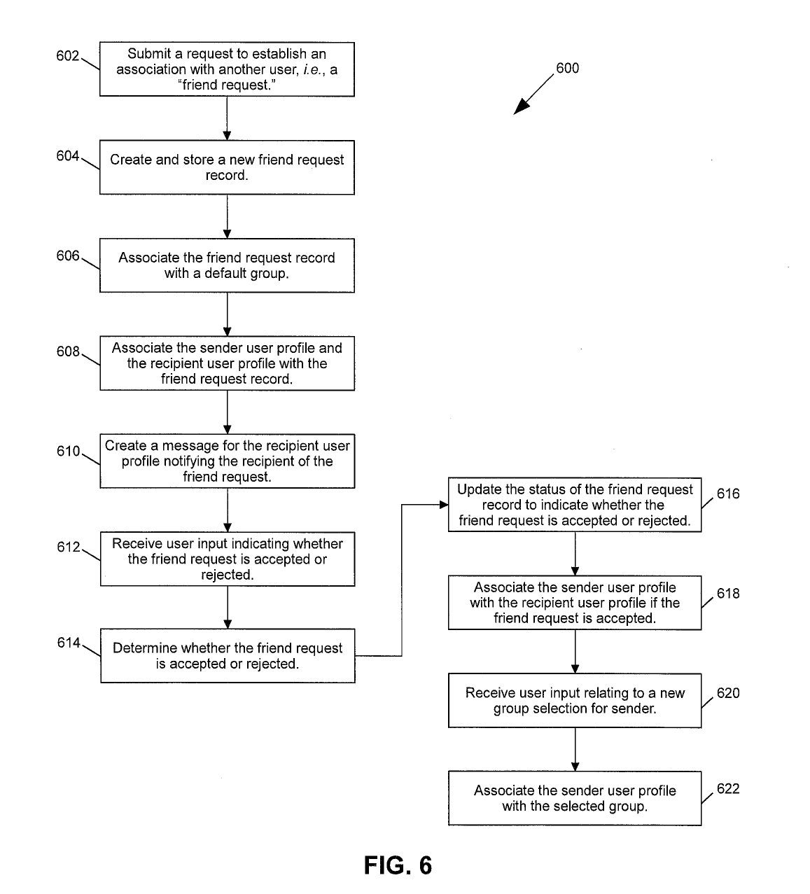

Referring to FIG. 6, a flowchart 600 of example method steps for establishing an association between users of the sports-themed social networking system 100 is shown. A user submits via an interface portal a request 156 to establish an association with another user, i.e., a friend request (step 602). The request management module 120, in this example, manages the friend request procedure. When a user submits a friend request 156, the request management module 120 may create a friend request record and store the friend request record at the data store 104 (step 604). The friend request record may also be associated with a status (e.g., “pending,” “accepted,” “rejected,” etc.) that indicates whether a user has accepted or rejected a friend request 156. When a friend request 156 is first created, the request management module 120 may set the status to, for example, “pending.” The friend request 156 may also be associated with a group (e.g., “teammate,” “fan,” “coach,” etc.). The friend request management module 120, in this example, may automatically associate the new friend request with a default group (step 606), e.g., the fan group. The request management module 120 may associate the friend request 156 with the respective user profiles of the sender and recipient of the friend request (step 608).

The request management module 120 may then create a message for the recipient of the friend request 156 that notifies the recipient the sender of the friend request desires to establish an association (step 610). The recipient of the friend request 156 may accept or reject the friend request by submitting user input to the social networking system 100 indicating whether the friend request is accepted or rejected (step 612). If the friend request 156 is rejected (step 614), then the request management module 120 may update the status of the friend request record as, for example, “rejected” (step 616). If the friend request is accepted (step 614), then the request management module may update the status of the friend request record as, for example, “accepted” (step 616) and establish an association between the respective user profiles for the sender and recipient of the friend request (step 618). For example, the request management module 120 may create a friend record and store the friend record in the data store 104. The request management module 120 may associate the friend record with the user profile for the sender of the friend request 156 with the user profile of the recipient of the friend request in order to establish an association between the sender and the recipient of the friend request.

Where the recipient of the friend request is a player, the player may reassign the user associated with the friend request from the default group (e.g., the fan group) to a different group. The player may select a new group (e.g., the teammate group, the coach group, etc.) to assign the user to; the group selection may be received as user input (step 620). The friend request management module may then associate the friend request with the group selected by the user (step 622).

### 3. Player Statistics

As mentioned above, a player may upload sports information that includes statistics 150 for the player. The sports-themed social networking system 100, in this example, may include a statistics management module 122 that manages statistics 150 uploaded by a player.

Statistics 150 for a player may be related to a game the player participated in. For a baseball game, as an example, statistics 150 may include: hits, runs, homeruns, runs-batted-in (RBIs), strike outs, walks, bases stolen, etc. A player may submit game-related information 164 and statistics 150 to the social networking system 100 as user input. Game-related information 164 may include, for example, the sport played, the date of the game, the location of the game, the opposing team, the final score, etc. The statistics management module 122, in this example, may create a new game record for the received statistics 150 and stored the new game record at the data store 104. The statistics management module 122 may also store the game-related information 164 and statistics 150 in the game record for the game or otherwise associate the game-related information and statistics with the game record.

The statistics management module 122 may also associate the game (e.g., a baseball game) with the player as well as a sport profile (e.g., a baseball sport profile) for the player by associating the game record with the user profile record and sport profile record for the player.

In this way, players may advantageously share game performances in an online social network. Accordingly the game statistics 150 for players may be available to other users of the sports-themed social networking system 100 that follow the player such as fans, coaches, and other players.

### 4. Player Footage

As mentioned above, a player may upload video items of game footage or highlight footage to the sports-themed social networking system. The media management module may associate the uploaded video items with the user profile for the player. Users may navigate via an interface portal to the user profile for the player and view the video items uploaded by the player.

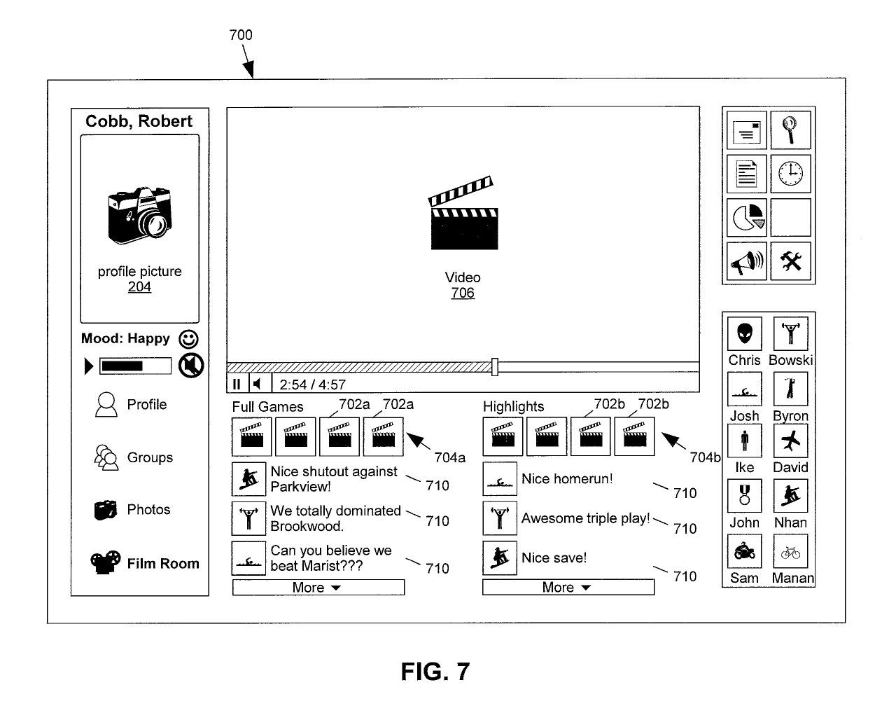

Referring to FIG. 7, an example of an implementation of an interface portal 700 displaying video items 702 uploaded by a player is shown. The interface portal 700 may display a list 704 of video items 702 uploaded by a player. The interface portal 700, in this example, displays two sets 704a and 704b of video items 702 uploaded by a player: full game video items 702a and highlight video items 702b. A user may select via the interface portal 700 a video item 702 from the list of video items 704. The interface portal 700 may then present the selected video item 706 at a video player 708 for playback of the video item.

A user may also submit via the interface portal 700 a post 710 relating to a video item 702 uploaded by the player. A message record for the post 710 may be created and stored at the data store 104. The message record for the post 710 may also be associated with the media item record for a video item 702 uploaded by a player. As shown by way of example in FIG. 7, users may submit posts 710 for video items 702a related to full game footage and video items 702b relating to highlight footage.

### 5. Transcripts

As mentioned above, a player may upload a school transcript 148 as a document item (e.g., a PDF file) to the sports-themed social networking system 100. The media management module 116 may receive the uploaded document item 148 and store the document item in the data store 104. The media management module 116 may also create a new media item record for the document item and associate the new media item record with the uploaded document item 148 as described above.

Also mentioned above, in some example implementations, only head coaches may have access to a transcript 148 uploaded by a player. A coach may request access to a transcript 148 for a player, and the request management module 120 of the sports-themed social networking system 100, in this example, may manage transcript requests 158.

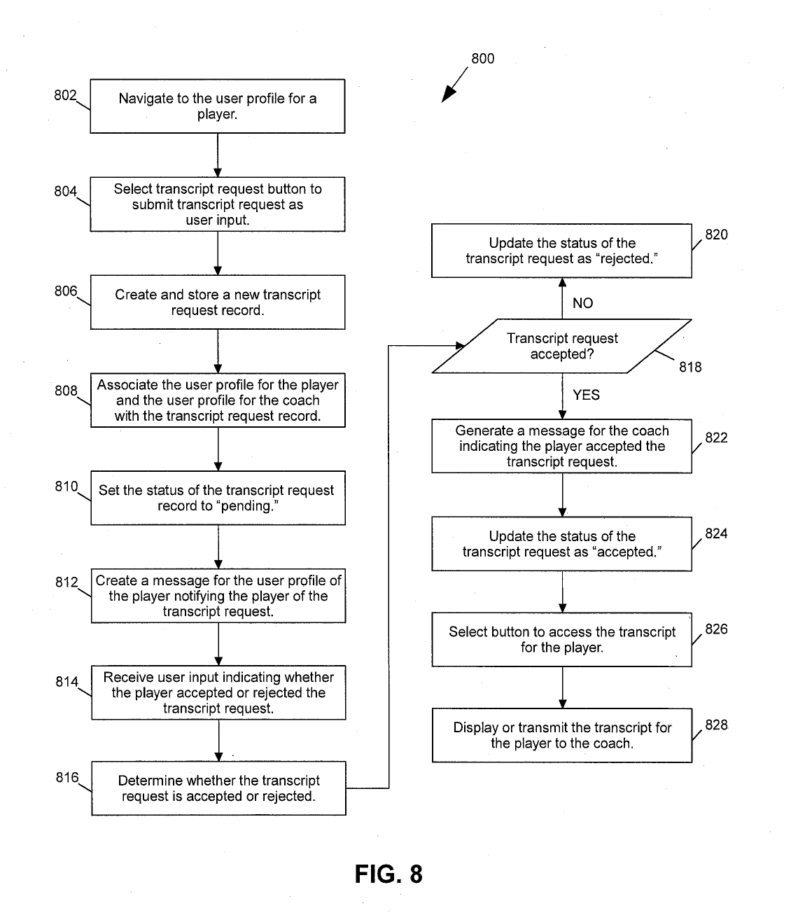

Referring to FIG. 8, a flowchart 800 of example method steps for managing a transcript request 158 is shown. A coach may navigate via an interface portal to the user profile for a player (step 802). The user profile for the player may include a button 314 (FIG. 3) to request a transcript 148 for the player. The coach may select the transcript request button 314 to submit a transcript request 158 as user input (step 804). The request management module 120 may then create a transcript request record and store the transcript request record at the data store 104 (step 806). The request management module 120 may associate the user profile for the player and the user profile for the coach with the transcript request record (step 808). The transcript request record may also be associated with a status (e.g., “pending,” “accepted,” “rejected,” etc.). When the request management module 120 creates the transcript request record, the request management module may set the status of the transcript request record to, for example, “pending” (step 810).

The request management module 120 may then generate a message for the player associated with the requested transcript 148 (step 812) that notifies the player the coach has requested access to the transcript for the player. The player may accept or reject the transcript request 158; acceptance or rejection of the transcript request may be received as user input (step 814). Whether the transcript has been accepted or rejected may then be determined (step 816). If the player rejects the transcript request 158 (step 818), then the request management module 120 may update the status of the transcript request record as “rejected” (step 820). If the player accepts the transcript request 158 (step 818), then the request management module 120 may generate a message for the coach indicating the player has accepted the transcript request (step 822). The request management module 120 may also update the status of the transcript request record as “accepted” when the player accepts the transcript request 158 (step 824).

If a player has accepted a transcript request 158, the coach may then navigate via the interface portal back to the user profile for the player. The coach may then select a button 316 (FIG. 3) to view or download the transcript for the player (step 826), and the transcript 148 may be displayed at the interface portal or transmitted to the coach as a document item, e.g., a PDF (step 828). In this way, the sports-themed social networking system 100 advantageously limits the communications between coaches and players thereby reducing the likelihood that improper communications will occur.

The sports-themed social networking system 100, in this example, also indicates whether the transcripts 148 and standardized test scores for a player have been verified. The transcript management module 124 of the sports-based social networking system 100, in this example, manages the verification of transcripts 148 and standardized test scores.

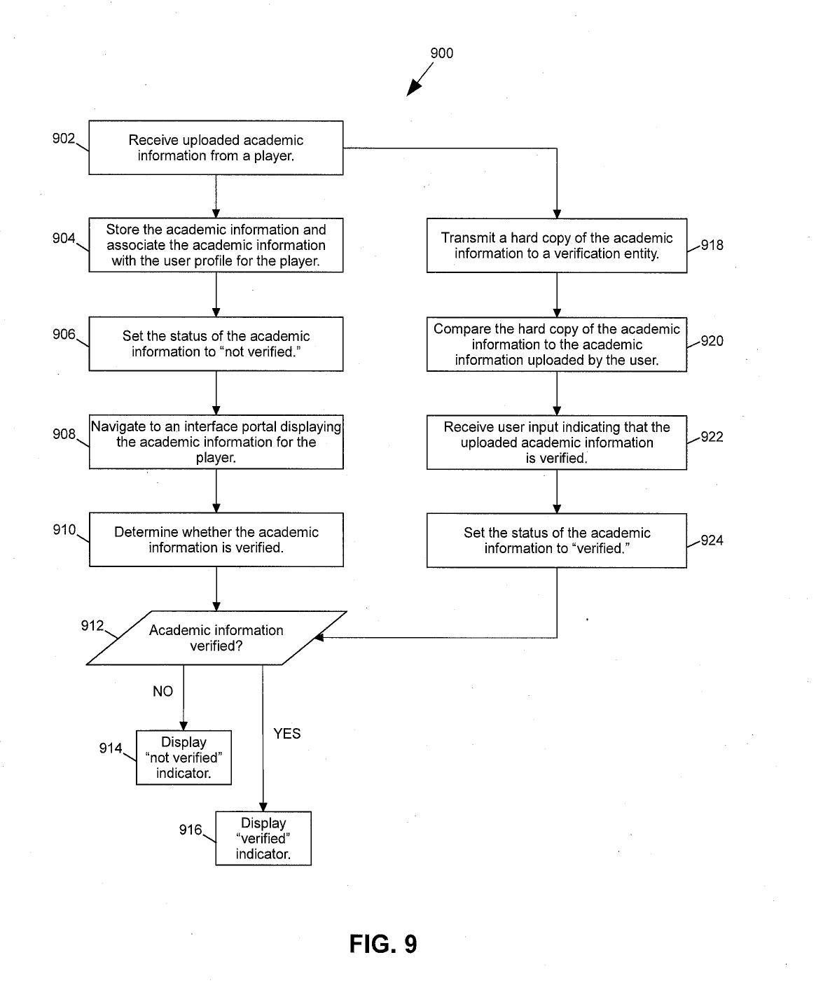

Referring to FIG. 9, a flowchart 900 of example method steps for verifying academic information associated with a player is shown. A player may upload academic information (e.g., GPA and test scores) as user input to the social networking system 100 (step 902). The profile management module 114 may store the academic information at the data store 104 and associate the academic information with the user profile for the player as described above (step 904). The GPA and test scores for a player may also be associated with a status (e.g., “verified” and “not verified”).

When a player first uploads the academic information, the transcript management module 124 may set the status of the academic related information to, for example, “not verified” (step 906). A user navigates via an interface portal to the user profile for the player and views the academic information for the player (step 908). Example academic information (GPA and SAT score) is shown in FIG. 3. The transcript management module 124 determines whether the academic information has been verified (step 910). If the academic information has not yet been verified (step 912), the transcript management module 124 may instruct the interface portal to display an indicator 318 (FIG. 3) that indicates the academic information has not been verified (step 914). In the example academic information shown in FIG. 3, the SAT score for the player has not been verified. Accordingly, the interface portal 302 displays an indicator 318 that indicates the SAT score for the player is not verified. If the academic information has been verified (step 912), then the transcript management module 124 may instruct the interface portal to display an indicator 320 (FIG. 3) that indicates the academic information has been verified (step 916). In the example academic information shown in FIG. 3, the GPA for the play has been verified. Accordingly, the interface portal 302 displays an indicator 320 that indicates the GPA for the player is verified.

Verification of academic information such as GPA and test scores may be verified manually. A hardcopy of the transcripts and standardized test scores for a player may be sent to a verification entity (step 918). The hardcopy may be acquired from the education institution for the player or from the institution providing the standardized test. The verification entity may be, for example, the entity that provides the sports-themed social networking system 100. The verification entity may then compare the GPA or test scores in the hardcopy to the GPA or test scores uploaded by a player (step 920). If the academic information in the hardcopy does not match the academic information uploaded by the player, then the verification entity may leave the status of the academic information stored in the data store as “not verified.” If the academic information in the hardcopy does match the academic information uploaded by the player, then the verification entity may submit user input to the social networking system (step 922) indicating that the academic information has been verified. The transcript management module 124 may receive the verification as user input and update the status of the academic information as “verified” (step 924). The transcript management module 124 may also store the date on which the academic information is verified. Once the academic information uploaded by a user has been verified, the transcript management module 124 may instruct the interface portal to display an indicator that indicates the academic information has been verified as discussed above. In the example academic information shown in FIG. 3, the GPA for the player has been verified. Accordingly the interface portal 302, in this example, displays an indicator 320 that indicates the GPA for the player is verified. The interface portal 302, in this example, displays the date 322 on which the GPA was verified.

### 6. Recruiting Suggestions

The sports-themed social networking system 100, in this example, includes a recruiting suggestion module 130. The recruiting suggestion module 130 may provide recruiting suggestions to players regarding the types of schools players should focus on for recruitment purposes. The recruiting suggestion module 130, in this example, provides recruiting suggestions to a player based on requests for the transcripts 148 of the player. For example, if a number of transcript requests 158 are associated with NCAA Division-II (D-II) schools, then the recruiting suggestion module 130 may suggest that the player focus on applying to D-II schools. In this way, the recruiting suggestion module 130 advantageously indicates what types of schools are interested in the player as a prospective student-athlete thereby allowing the player to efficiently focus recruiting efforts.

To provide a recruiting suggestion, the recruiting suggestion module 130, in this example, may query the data store 104 for transcript request records associated with a player. The recruiting suggestion module 130 may also query the data store 104 for the respective user profiles of coaches that have requested the transcript for the player as well as the respective school profiles associated with the coaches. The recruitment suggestion module 130 may determine the athletic level for the schools associated with the transcript request record (e.g., NCAA D-I, NCAA D-II, NCAA D-III, etc.). The recruiting suggestion module 130 may determine the total number of each school level type for schools associated with the transcript request 158 for the player. The recruiting suggestion module 130 may then determine a recruiting suggestion based on the total number of school level types. The recruiting suggestion module 130 may suggest a school level where, for example, the number of transcript requests 158 at the school level is at least around 25% of the total number of overall transcript requests for the player. The recruiting suggestion module 130 may suggest one or more schools.

For example, if the recruiting suggestion module 130 determines that the transcripts 148 for a player have been requested, e.g., 50 times-10 times by NCAA D-I schools, 20 times by NCAA D-II schools, and 20 times by NCAA D-III schools—then the recruiting suggestion module may suggest the player focus recruiting efforts at NCAA D-II and D-III schools. It will be understood that additional or alternative approaches to determining and providing recruiting suggestions may selectively be employed.

### 7. Player Tracking

As mentioned above, coaches may use the sports-themed social networking system 100 as an athletic recruiting tool. Coaches may search for players in order to identify potential targets for recruiting efforts. Coaches may browse the personal information 136 and sports information 138 uploaded by players including game performances 164 and game statistics 150.

The sports-themed social networking system 100, in this example, may automatically present to a coach recent online social networking activities a player engages in. For example, the social networking system 100 may automatically present recent posts 144, video items 142, or game statistics 150 uploaded by a player. A coach may select via an interface portal one or more players to track. When a coach tracks a player, the coach interface portal 170 may present a feed of recent social networking activities that followed players engage in. In the context of the sports-themed social networking system 100, a coach tracking a player may be referred to as a “season pass.”

The sports-themed social networking system 100, in this example, includes a player tracking module 128 that manages the automatic presentation of the online activities of players to coaches. When a coach selects a player to track, the player tracking module 128 may establish an association between the coach and the player. For example, the player tracking module 128 may associate the user profile for the player with the user profile for the coach.

The sports-themed social networking system 100 may maintain an activity log 152 for each player. In this example, an activity log record may be stored at the data store 104 and associated with the user profile for the player. The activity log 152 may be updated by, for example, the profile management module 114, the media management module 116, the transcript management module 124, or the statistics management module 122 when, for example, the player uploads new media items 142, personal information 136, sports information 138, or academic information, e.g., transcripts 148. The activity log 152 may be updated by adding a new activity entry to the activity log. The activity entry may include, for example, a short description of the activity to the activity log along with a date and time the player performed the activity. It will be understood that additional or alternative approaches to maintaining an activity log 152 for a player may be selectively employed.

A coach may track a set of one or more players, and the social networking activities tracked players engage in may be presented in an activity feed at the coach interface portal 170. When a coach navigates via the coach interface portal 170 to the tracked player activity feed, the player tracking module 128 may query the data store 104 for the respective activity logs 152 of tracked players. The player tracking module 128 may then select new activity log entries for presentation in the activity feed at the coach interface portal 170. The coach interface portal 170 may present the new activity entries for tracked players in an activity feed for the coach to review.

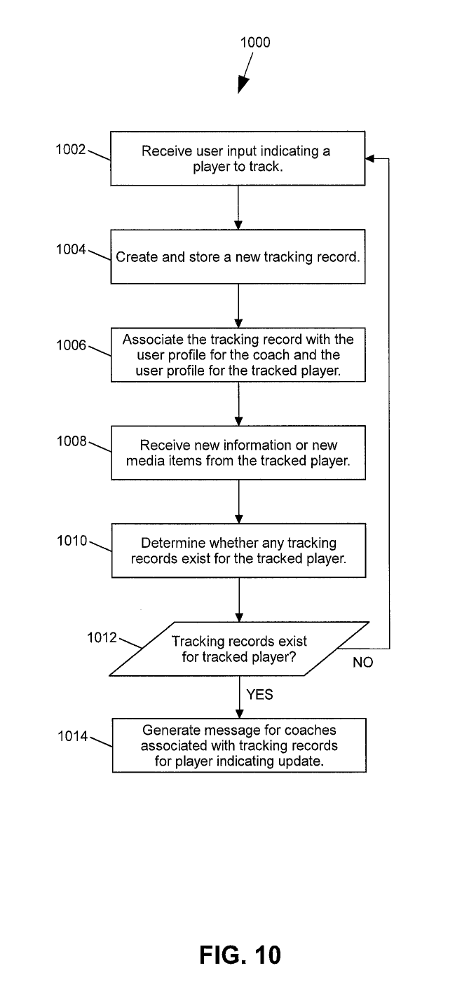

Alternatively, the player tracking module 128 may send a message to the coach when a tracked player uploads new media items 142 or uploads new personal information 136, sports information 138, or academic information, e.g., transcripts 148. Referring to FIG. 10, a flowchart 1000 of example method steps for tracking a player is shown. A coach may select via the coach interface portal 170 a player to track; the selection may be received as user input (step 1002). In this alternative approach, the player tracking module 128 may create a new tracking record and store the new tracking record at the data store 104 (step 1004). The player tracking module 128 may establish an association between the coach and the tracked player (step 1006) by, for example, associating the tracking record with the user profile of the coach and the user profile of the player. When a player uploads new media items 142 or new information (step 1008), the player tracking module 128 may query the data store 104 to determine if any tracking records exist for the player (step 1010). If one or more tracking records exist for the player (step 1012, then one or more coaches have selected to track the player. The player tracking module 128 may then generate and send messages to the coaches respectively associated with the tracking records for the player (step 1014) notifying the coaches that the player has upload new media items 142 or information to the social networking system 100.

In this way, the sports-themed social networking system 100 may advantageously present coaches with new updates to the user profiles of tracked players such as, for example, when a player uploads a new video item 142 or uploads new game statistics 150. It will be understood that additional or alternative approaches to automatically presenting the online activates of players to coaches may selectively be employed.

### 8. Visitations

The sports-themed social networking system 100 may also manage visitation requests 160 when a coach would like to visit with a player for recruiting purposes. The request management module 120, in this example, may manage visitation requests 160.

A coach may request via the coach interface portal 170 a visit with a player, i.e., a potential recruiting target. A visit may be an official visit or a non-official visit. When a coach submits a visitation request 160, the coach interface portal 170 presents a visitation form for the coach to complete. A coach may supply visitation-related information as user input in order to complete the form. The visitation form may include some or all of the following visitation information: first name, middle name, and last name of the player; home address of the player; date of birth of the player, phone number of the player; names of the parents of the player; phone number for the parents of the player. The system 100 may automatically populate the visitation form using the stored personal information 136 associated with the player. The visitation information may also include the airports the player will arrive at for the visitation and the airport the player will depart from when leaving for the visitation. Similarly, the visitation information may include preferred travel times and confirmed travel times. The coach may provide arrival airport information, and the player may provide the departing airport information. The visitation information may also include the number of tickets a player needs for the visitation—e.g., a player traveling with one parent may indicate that two tickets are needed, one for the player and one for the parent. The visitation information may also include accommodation information for the visitation, and the coach may provide the accommodation information. For example, the coach may indicate the hotel the player will stay at during the visitation. As another example, an athlete at the school the player visits may host the player during the visit, and the accommodation information may indicate which athlete will host the player during the visit. The visitation information may be stored in the data store and associated with the visitation request.

Once a coach has filled in the form with the visitation information, the request management module 120, in this example, sends a message to the player that notifies the player of the visitation request 160. The message to the player, in this example, includes a link to the visitation form for the player to complete. The player may also fill in the form with visitation information as discussed above. Once a player has completed the form, the request management module 120 may send respective confirmation messages to both the coach and the player that confirms the visitation request 160. The confirmation may also include a notice requesting that the parents of the player contact the coach (e.g., within 24 hours) to authorize the visitation request 106. A coach may upload an itinerary as a document media item 142 and associate the itinerary with the visitation request. The coach may then send a message to the player with the visitation itinerary attached.

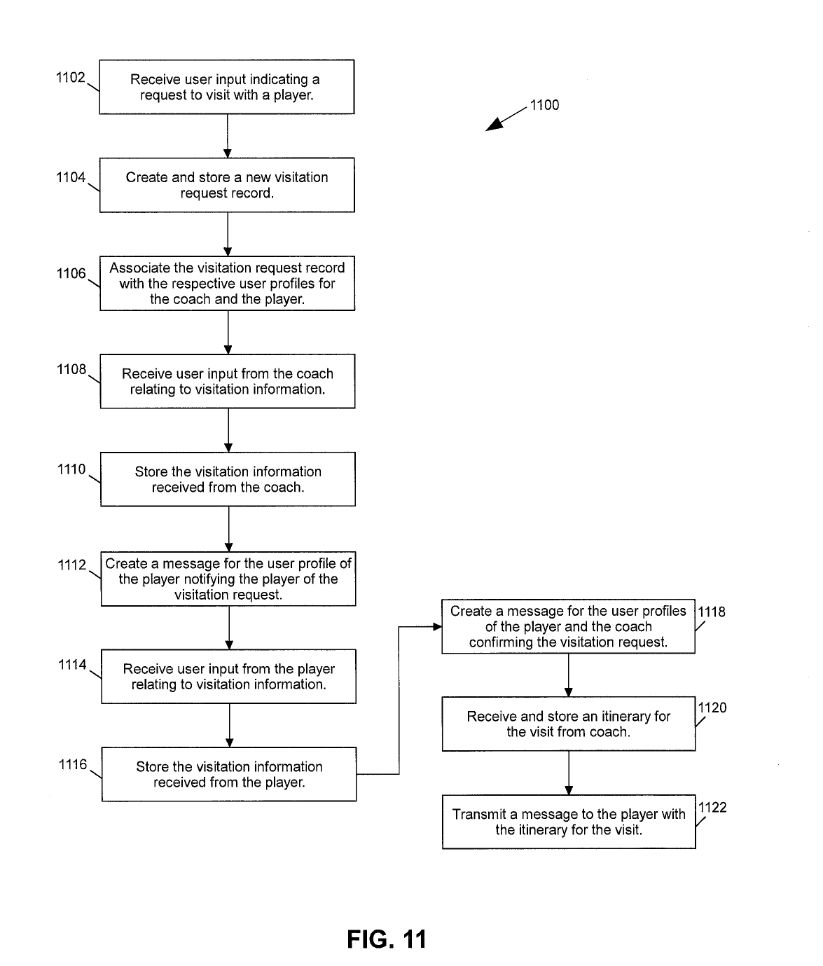

Referring to FIG. 11, a flowchart 1100 of example method steps for managing a visitation request 160 is shown. A coach may submit via the coach interface portal 170 a request 160 to visit with a player; the visitation request may be received as user input (step 1102). When a coach submits a visitation request 160, the request management module 120 may create a new visitation request record and store the new visitation request record at the data store 104 (step 1104). The request management module 120 may also establish an association between the visitation request and the coach and player (step 1106) by, for example, associating the visitation request record with the user profile of the coach and the user profile of the player. The coach may submit via the coach interface portal 170 the visitation-related information as user input to fill out the visitation form (step 1108). The visitation-related information may be stored at the data store 104 (step 1110) in the visitation request record or otherwise associated with the visitation request record. The request management module 120 may generate and send a message to the player (step 1112) notifying the player of the visitation request 160. The player may then submit via the player interface portal 168 visitation-related information as user input (step 1114), which may also be stored at the data store 104 (step 1116) in the visitation request record or otherwise associated with the visitation request record. The request management module 120 may then generate and send respective messages to the coach and the player confirming the visit (step 1118). The coach may then upload an itinerary as, for example, a document media item 142 (step 1120), which may be stored at the data store 104 and associated with the visitation request record. The coach may send a message to the player with the itinerary document media item 142 attached to the message (step 1122). It will be understood that additional or alternative approaches to managing visitation requests 160 may selectively be employed.

### 9. Scouting Footage

As mentioned above, coaches may upload video items 142 and share uploaded video items with other coaches and players. The video items 142 may be, for example, full game footage, highlight footage, personal footage, etc. The coach interface portal 170, in this example, may display a list of video items 142 a coach has uploaded. The coach interface portal 170 may also include user interface controls for sharing video items with other coaches and players.

A coach may share a video item 142 with another coach by granting the other coach access to view the video item. In some example implementations, a coach may grant another coach access to a video item 142 by sending the other coach a password associated with the shared video item. The other coach may supply the password to the social networking system 100 as user input to view the shared video item 142. Access to a shared video item 142 may expire after a predetermined time period. For example, a password to access a shared video item 142 may expire after 48 hours such that a coach receiving the password may no longer access the shared video item.

A coach may also share a video item 142 with one or more players by associating the respective user profiles for the players with the video item. Players may receive a message indicating a coach has shared a video item 142 with the players. Players may navigate to the shared video item 142, and the social networking system 100, in this example, may log when a player views a shared video item.

In this way, coaches may advantageously share video items 142 of scouting footage with players prior to a game with an opponent. For example, a coach may upload scouting footage featuring an upcoming opponent. The coach may also upload scouting-related information (i.e., a “scouting report”) regarding the upcoming opponent, and the scouting report may be associated with the upcoming video footage. An interface portal may display the scouting report with the scouting footage for players to review when viewing the scouting footage. Additionally or alternatively, the scouting report may be included in the message transmitted to players notifying them of a new shared video item 142. The social networking system 100 may also make the scouting report downloadable as a document item such as, for example, a PDF file.

The sports-themed social networking system 100 may also create and maintain a log of players associated with a shared video item 142 that have viewed the shared video item. When a player views a shared video, the social networking system 100 may update the log with the date and time the player viewed the video. In this way, coaches may advantageously determine which players have or have not viewed a shared video item 142.

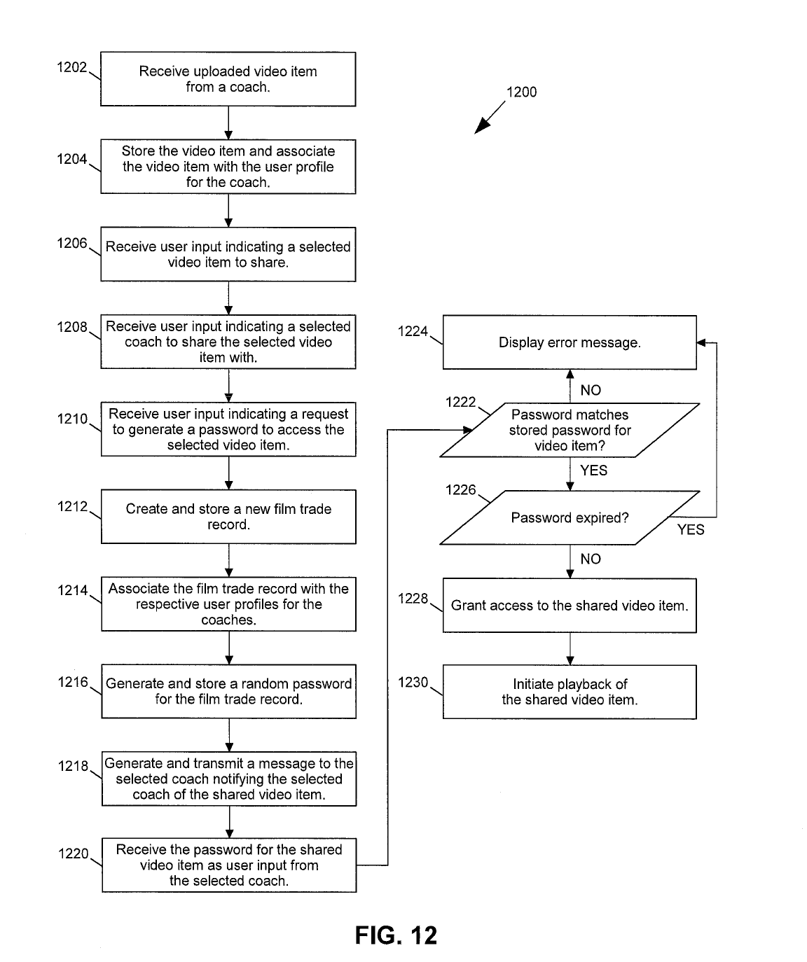

The film trading management module 126 of the sports-themed social networking system 100, in this example, manages the sharing of video items 142 with other coaches and with players. Referring to FIG. 12, a flowchart 1200 of example method steps for sharing a video item 142 with a coach is shown. A coach uploads a video item 142 to the social networking system 100 (step 1202). The media management module 116 stores the video item 142 at the data store 104 and associates the uploaded video item with the coach (step 1204). The media management module 116 may create a media item record in the data store 104 and associate the media item record with the uploaded media item 142 as described above.

The coach may then select via the coach interface portal 170 an uploaded video item 142 to share with another coach; the video item selection may be received as user input (step 1206). The coach may then select via the coach interface portal 170 another coach to share the uploaded video item 142 with; the coach selection may also be received as user input (step 1208). The coach may then submit a request to generate a password; the password request may also be received as user input (step 1210) such that the other coach may view the shared video item 142. The film trading management module 126 may create a film trade record (step 1212) when the coach requests a password for the selected video item 142. The film trading management module 126 may store the film trade record at the data store 104. The film trading management module 126 may also associate the new film trade record with the coach that uploaded the video item 142 and the selected coach to share the video item with (step 1214) by, for example, associated the film trade record with the respective user profiles for the coaches. The film trading management module 126 may also automatically generate a random password (step 1216) for the film trade record and store the password in the film trade record or otherwise associate the password with the film trade record. The film trading management module 126 may also store the date and time the coach requested generation of a password for the selected video item 142 in order to subsequently determine whether the password for the selected video item has expired.

A message may be created and sent to the selected coach (step 1218) notifying the selected coach of the shared video item 142. The message may include the password the other coach may use to access the shared video item 142. The other coach may navigate to the shared video item 142 and supply the password as user input to the social networking system 100 (step 1220). The film trading management module 126 determines if the supplied password matches the password generated for the shared video (step 1222). If the supplied password does not match the password stored in the data store 104, then the interface portal may display an error message (step 1224) indicating the password is incorrect, and the film trading management module 126 may deny the other coach access to view the shared video item 142. If the supplied password matches the password stored in the data store 104, then the film trading management module 126 may determine if the password for the shared video item 142 has expired (step 1226). For example, the film trading management module 126 may compare the date and time the password was generated with the present date and time. If the present date and time is outside the expiration period for the password, then the interface portal may display an error message (step 1224) indicating that the password has expired, and the film trading management module 126 may deny the other coach access to view the shared video item 142. If the present date and time is within the expiration period, then the film trading management module 126 may grant the other coach access to view the shared video item 142 (step 1228), and the interface portal may present the shared video item 142 for playback (step 1230).

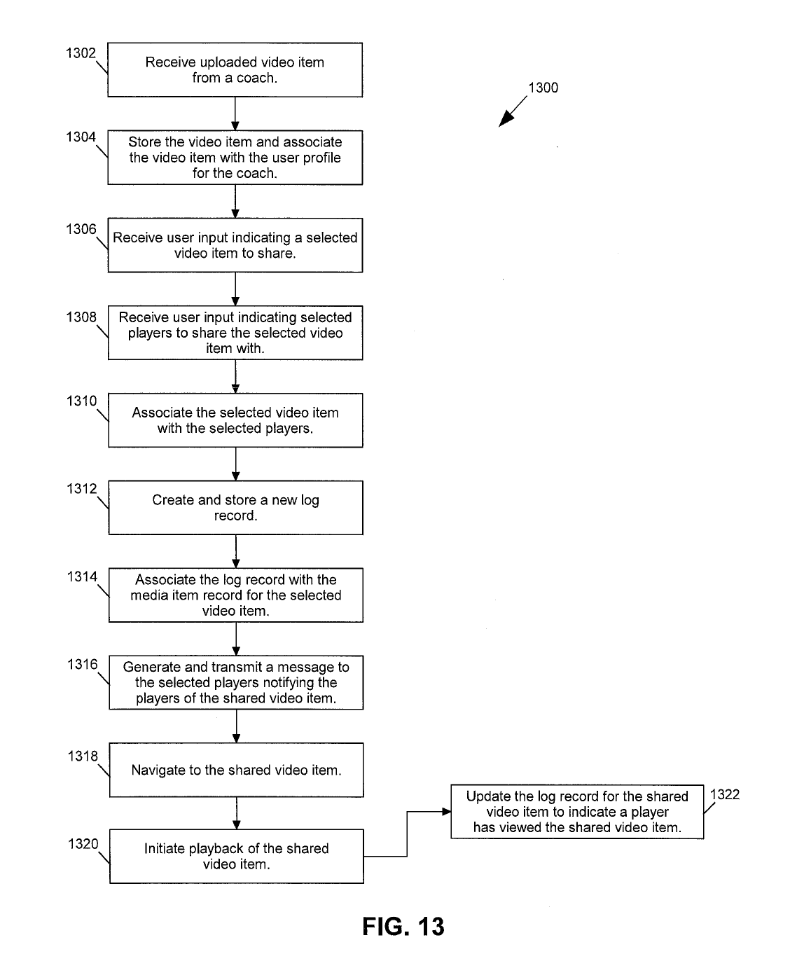

Referring now to FIG. 13, a flowchart 1300 of example method steps for sharing a video item 142 with a set of players is shown. A coach may upload a video item 142 to the social networking system 100 (step 1302). The media management module 116 stores the video item 142 at the data store 104 and associates the uploaded video item with the user profile for the coach (step 1304) as described above. The coach may then select via the coach interface portal 170 an uploaded video item 142 to share with one or more players; the video selection may be received as user input (step 1306). The coach may then select via the coach interface portal 170 a set of players to share the selected video item 142 with; the player selections may also be received as user input (step 1308). The film trading management module 126 may associate the selected players with the shared video item 142 (step 1310) by, for example, associating the user profile record for the player with the media item record for the video item. Additionally or alternatively, the film trading management module 126 may associate the selected player with the selected video item 142 by storing an email address for the player in the media item record for the selected video item or otherwise associating the email address for the player with the media item record for the selected video item. The film trading management module 126 may also create and store a log record for the shared video item 142 (step 1312) and associate the log record with the media item record for the video item (step 1314).

The film trading management module 126 may then generate a message for the players notifying the players that the coach has shared a video item 142 with the players (step 1316). The message may include the scouting report, for example, within the body of the message or as an attached document item (e.g., a PDF file). The player may then navigate via an interface portal to the shared video item 142 (step 1318) in order to view the shared video item. The player may then initiate playback of the shared video item 142 presented at the interface portal (step 1320). When the player views the shared video item 142, the film trading management module 126 may update the log record associated with the shared video item 142 (step 1322) in order to indicate that the player has viewed the shared video item. For example, the film trading management module 126 may update the log record with the date and time the player viewed the shared video item 142. In this way, a coach may review the log record to determine which players have and have not viewed the shared video item 142.

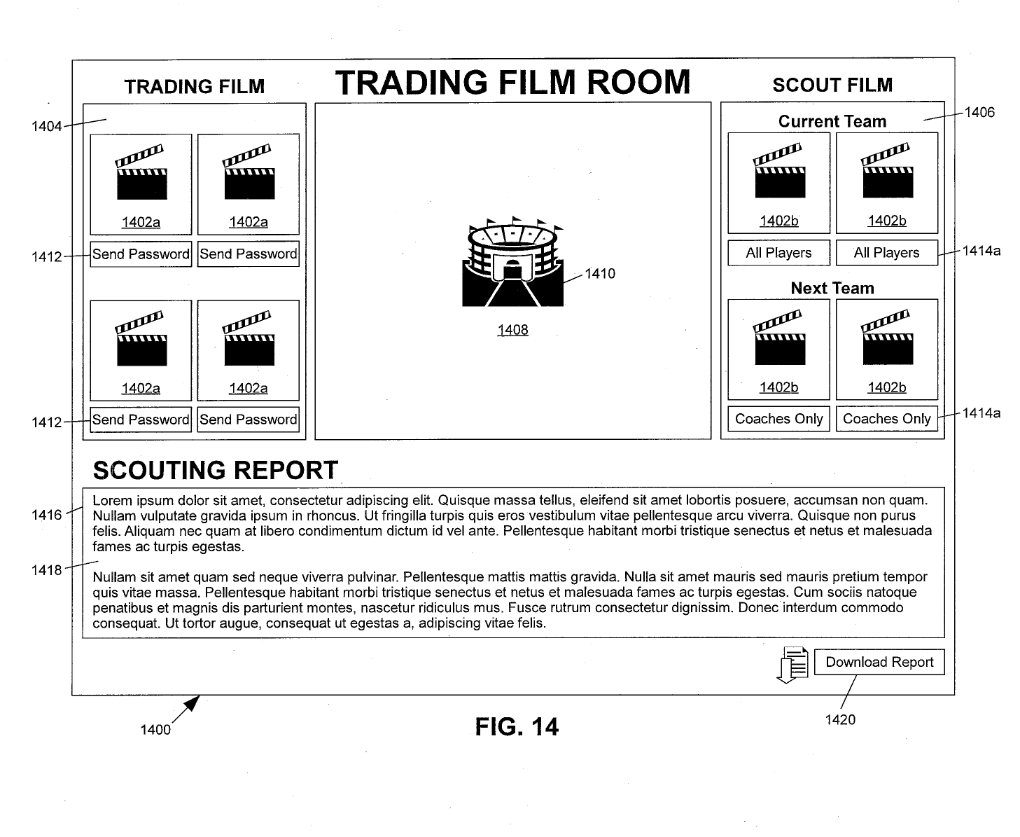

Referring to FIG. 14, an example of an implementation of an interface portal 1400 displaying video items 1402 to share is shown. The interface portal 1400, in this example, includes a panel 1404 to share video items 1402a (“trade film”) with other coaches (i.e., a film trading panel) and a panel 1406 to share video items 1402b (“scout film”) with players and coaches (i.e., a scout film panel). The interface portal 1400 may also include a center panel 1408 that presents a video player for playing a selected video item 1402 or, additionally or alternatively, an image item 1410 such as, for example, a school logo.

The film trading panel 1404 may present one or more video items 1402a at the interface portal 1400. The interface portal 1400, in this example, presents four video items 1402a to share with other coaches. A video item 1402a in the film trading panel 1404 may be associated with a user interface element 1412 such as, for example, a button (“Send Password”) as shown by way of example in FIG. 14. A coach may select the button 1412 associated with a video item 1402a in the film trading panel 1404 to initiate the film trading process, i.e., select a coach to share the video item with, generate a password, and notify the coach as discussed above with reference to FIG. 12.

The scout film panel 1406 may also present one or more video items 1402b at the interface portal 1400. As mentioned above, the scout film panel 1406 may present video items 1402b for a current opponent (“current team”) and an upcoming opponent (“next team”). The scout film panel 1406, in this example, presents two video items 1402b for the current upcoming team and two video items 1402b for the next upcoming team. A coach may also share the scout film video items 1402b with players and other coaches (e.g., assistant coaches) who are part of a team associated with the coach sharing the video item. A scout film video item 1402b may also be associated with a user interface element 1414, e.g., a button to initiate the scout film sharing process. In this example, video items 1402b associated with an upcoming opponent may only be accessible to other coaches associated with the team. Accordingly selecting the button 1414b (“Coaches Only”) may initiate the process of sharing a scout film video item 1402b with the coaches. Likewise selecting the button 1414a (“All Players”) may initiate the process of sharing a scout film video item 1402b with the players of the team as discussed above with reference to FIG. 13.

The interface portal 1400 in this example may also include a panel 1416 to present a scouting report 1418 associated with the a video item 1402 such as, for example, a trading film report for a trading film video item 1402a or a scouting report for a scouting film video item 1402b. The interface portal 1400 may also include a user interface element 1420, e.g., button, to download the report 1418 as, for example, a document item (e.g., a PDF file).

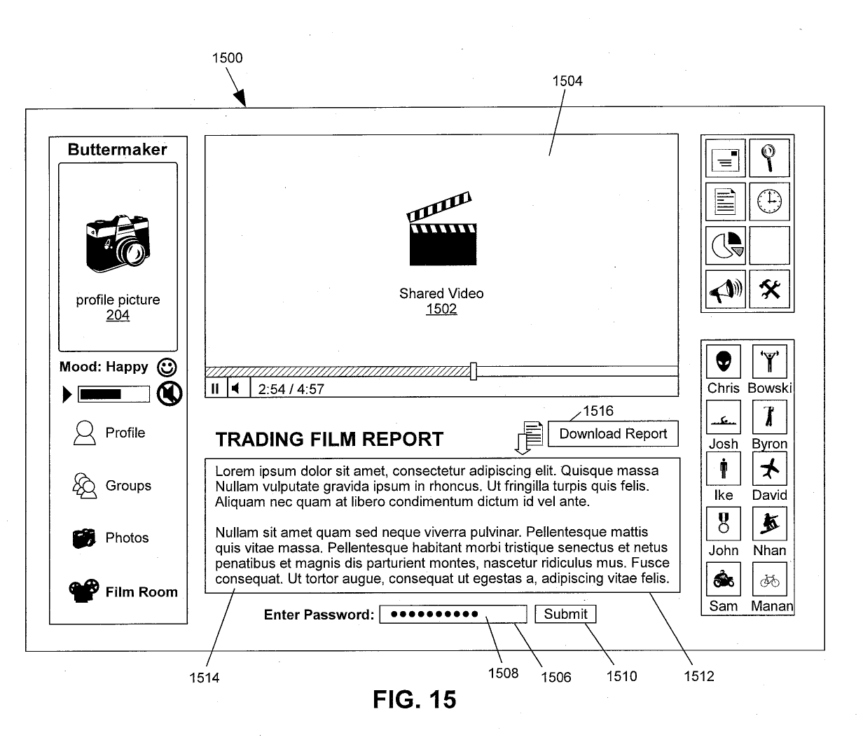

Referring now to FIG. 15, an example of an implementation of an interface portal 1500 displaying a shared video item 1502 is shown. The interface portal 1500, in this example, includes a video player 1504 for playing the shared video item 1502. The interface portal 1500, in this example, also includes a user input element 1506, e.g., a textbox, for receiving a password 1508 from the coach the video 1502 was shared with, and a button 1510 for submitting the password. If the password 1508 provided by the coach matches the password associated with the shared video item 1502, and if the password associated with the shared video item has not expired, then the interface portal 1500 may present the shard video item at the video player 1504. The interface portal 1500 may also include a panel 1512 that presents a report 1514 associated with the video item 1502 being presented as well as a user interface element 1516 (e.g., a button) to download the report 1514 as a document item, e.g., a PDF file.

### 10. Compliance Management

As mentioned above, the sports-themed social networking system 100 provides the ability to flag and monitor communications between players, coaches, and fans. If a coach or a player believes a message from another user may potentially violate communication rules for recruiting activities, then the coach or the player may flag the user profile for the user sending the communication. When a user profile is flagged, the social networking system 100 sends the original message to the intended recipient, but the compliance management module 132 also sends the message to a compliance entity that may, for example, review and archive the message. A compliance entity may be, for example, the administrator associated with a coach. Additionally or alternatively, a compliance entity may not be associated with the sports-themed social network, and the compliance management module 132 may send the message to an email address for, e.g., a compliance department of a school.

If a coach flags a player, fan, or another coach, then the compliance management module 132, in this example, forwards messages between the coach and the flagged user to the administrator associated with the coach. If a player flags a coach, then the compliance management module 132, in this example, forwards messages between the player and the coach to the administrator associated with the coach. Users may remove flags from user profiles such that the compliance management module 132 does not forward further communications to a compliance entity.

The system 100, in this example, may be configured to allow players to flag fans and coaches. For example, the system 100 may be configured to allow players to flag coaches and fans once the player has signed a letter of intent, which may be indicated by a status flag in the data store 104 that is associated with the player profile. Once the player signs a letter of intent to attend a school, the school may be set as an administrator of the player profile for the player. The player profile for the player may be associated with the school profile for the school in the data store 104 to indicate that the school is an administrator of the player. The system 100, in this example, may also be configured such that a player may not be allowed to flag coaches and fans until the player signs a letter of intent and has a school administering the player profile for the player.

The system 100, in this example, may be further configured such that coaches may flag fans, players, and coaches. In some example implementations, the system 100 may be configured such that coaches may only be allowed to flag coaches that they are not associated with.

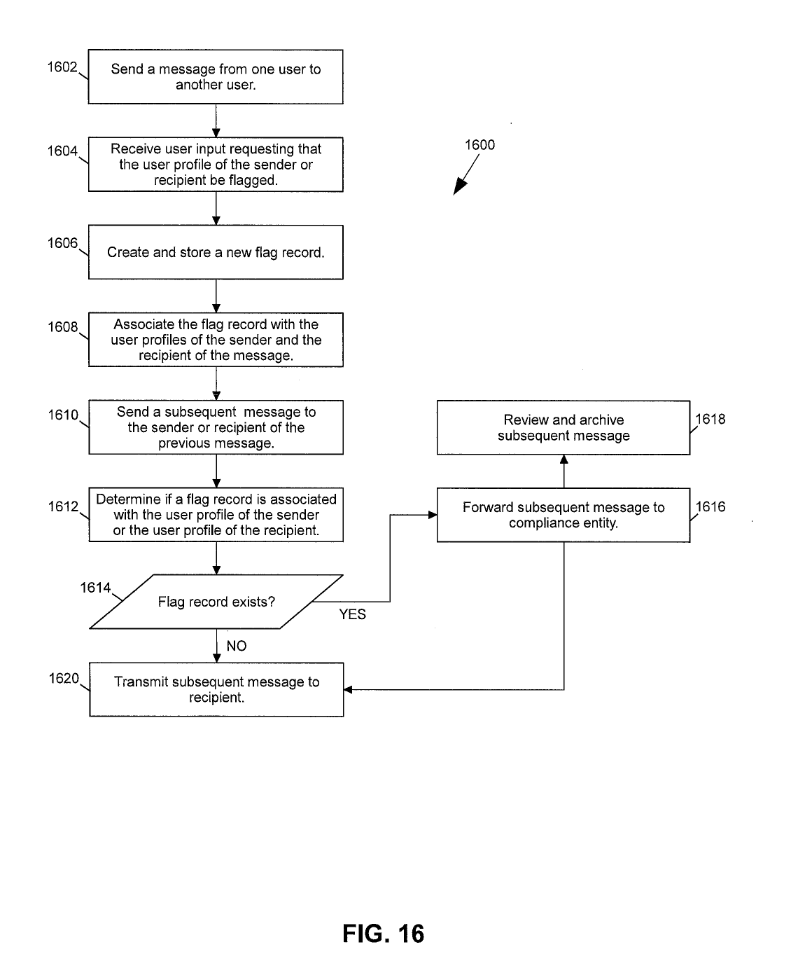

The compliance management module 132 of the sports-themed social networking system 100, in this example, manages the flagging and tracking of messages between users. Referring to FIG. 16, a flowchart 1600 of example method steps for monitoring communications on a social networking system 100 is shown. A user may send another user a message (step 1602), for example a public or private message. The recipient of the message may flag the user profile for the sender of the message by submitting via an interface portal a flag request 162; the flag request may be received as user input (step 1604). In response to receipt of the flag request 162, the compliance management module 132, in this example, may flag a user profile by creating a flag record and storing the flag record at the data store 104 (step 1606). The compliance management module 132 may also establish an association between the recipient of the message and the sender of the message (step 1608) by, for example, associating the flag record with the respective user profiles of the sender and the recipient of the message. Once a profile has been flagged, the compliance management module 132 will forward any subsequent communications between the users to a compliance management entity. Where the user profile for a coach is associated with a flag record, the compliance management entity may be, for example, the administrator associated with the coach.

When the sender or recipient of the previous message sends a subsequent message (step 1610), the compliance management module 132, in this example, queries the data store 104 to determine if there exists a flag record associated with the sender and the recipient of the message (step 1612). If a flag record exists that is associated with the sender and the recipient of the message (step 1614), then the compliance management module 132 determines that the communications between the users has been flagged. Accordingly the compliance management module 132 forwards the message to a compliance entity, e.g., an administrator associated with one of the users (step 1616). The compliance entity may review the message or archive the message for further review (step 1618). Even though the subsequent message is forwarded to a compliance entity, the message is still transmitted to the recipient as normal (step 1620). If a flag is removed from a user profile for a user, the compliance management module 132 may delete the flag record associated with the user profile.

### Additional Technical Information

It will be understood and appreciated that one or more of the processes, sub-processes, and process steps described in connection with FIGS. 1-16 may be performed by hardware, software, or a combination of hardware and software on one or more electronic or digitally-controlled devices. The software may reside in a software memory (not shown) in a suitable electronic processing component or system such as, for example, one or more of the functional systems, devices, components, modules, or sub-modules schematically depicted in FIGS. 1-16. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module, which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., a system 100 for monitoring communications on a social network in FIG. 1), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A system for managing communications on a social network comprising:
a profile management module that manages a set of user profiles, where individual user profiles in the set of user profiles are respectively associated with a set of sports profiles; and
a compliance management module that flags one of the user profiles in the set of user profiles in response to receipt of a flag request, where the compliance management module sends a communication transmitted to or transmitted from the user profile to a compliance entity in response to a determination that the user profile is flagged when the communication is transmitted.

2. The system of claim 1 wherein:
in response to receipt of the flag request, the compliance management module creates and stores a flag record associated with the user profile in a data store; and
in response to creation of a new communication associated with the user profile, the compliance management module determines whether the data store includes an existing flag record associated with the user profile.

3. The system of claim 1 wherein:
individual user profiles in the set of user profiles are associated with at least one user type; and
the user type is selected from the group consisting of: a player user type, a teammate user type, an administrator user type, a coach user type, or a fan user type.

4. The system of claim 3 wherein:
a user profile associated with a player user type is associated with a set of personal information, sports information, and academic information; and
access to the set of personal information, sports information, and academic information is restricted based on user type such that a user profile associated with a coach user type or a fan user type has access to a subset of the set of personal information, sports information, and academic information.

5. The system of claim 3 further comprising:
a request management module that associates a first user profile and a second user profile in the set of user profiles and automatically sets the user type of the second user profile to the fan user type in response to receipt of a confirmation of a request to associate the first user profile with the second user profile; and
wherein the request management module sets the user type of the second user profile to a coach user type or a teammate user type in response to receipt of user input.

6. The system of claim 1 wherein one of the user profiles in the set of user profiles is associated with a transcript and further comprising:
a transcript management module that indicates a verification status associated with the transcript; and
wherein the transcript management module sets the verification status associated with the transcript to verified in response to receipt of user input that indicates the transcript has been verified.

7. The system of claim 6 further comprising a request management module that creates and stores a transcript request record at a data store and associates the transcript request record with the transcript in response to receipt of a request to access the transcript.

8. The system of claim 7 further comprising a recruiting suggestion module that determines a recruiting suggestion based at least in part on a set of transcript request records respectively associated with the transcript.

9. The system of claim 8 wherein:
individual transcript request records in the set of transcript request records are respectively associated with a school profile record; and
the recruiting suggestion module determines the recruiting suggestion based at least in part on school information associated with the school profile record.

10. A computer-implemented method of managing communications on a social network comprising:
maintaining a set of electronic user profiles, where individual user profiles in the set of user profiles are respectively associated with a set of electronic sports profiles;
flagging one of the user profiles in the set of user profiles in response to receipt of a flag request; and
sending a communication transmitted to or transmitted from the user profile to a compliance entity in response to a determination that the user profile is flagged when the communication is transmitted.

11. The computer-implemented method of claim 10 further comprising:
creating and storing a flag record associated with the user profile in a data store; and
determining whether the data store includes an existing flag record associated with the user profile in response to creation of a new communication associated with the user profile.

12. The computer-implemented method of claim 10 wherein:
individual user profiles in the set of user profiles are associated with at least one user type; and
the user type is selected from the group consisting of: a player user type, a teammate user type, an administrator user type, a coach user type, or a fan user type.

13. The computer-implemented method of claim 12 further comprising:
associating a set of personal information, sports information, and academic information with a user profile associated with a player user type; and
restricting access to the set of personal information, sports information, and academic information based on user type such that a user profile associated with a coach user type or a fan user type has access to a subset of the set of personal information, sports information, and academic information.

14. The computer-implemented method of claim 12 further comprising:
associating a first user profile and a second user profile in the set of user profiles in response to receipt of a confirmation of a request to associate the first user profile with the second user profile;
automatically sets the user type of the second user profile to the fan user type; and
setting the user type of the second user profile to a coach user type or a teammate user type in response to receipt of user input identifying the second user profile as associated with a coach user type or a teammate user type.

15. The computer-implemented method of claim 10 wherein one of the user profiles in the set of user profiles is associated with a transcript and further comprising:
providing an indication of a verification status associated with the transcript; and
setting the verification status associated with the transcript to verified in response to receipt of user input that indicates the transcript has been verified.

16. The system of claim 15 further comprising:
creating and storing a transcript request record at a data store in response to receipt of a request to access the transcript; and
associating the transcript request record with the transcript;

17. The computer-implemented method of claim 16 further comprising determining a recruiting suggestion based at least in part on a set of transcript request records respectively associated with the transcript.

18. The computer-implemented method of claim 17 wherein individual transcript request records in the set of transcript request records are respectively associated with a school profile record and further comprising:
determining the recruiting suggestions based at least in part on school information associated with the school profile record.

19. A computer-implemented method of monitoring communications on a social network comprising:
determining that a first user profile in a set of user profiles of a sports-themed social network has transmitted a communication to a second user profile in the set of user profiles;
determining whether the first user profile or the second user profile is flagged; and
sending the communication to a compliance entity in response to a determination that at least one of the first user profile or the second user profile is flagged.

20. The computer-implemented method of claim 19 further comprising flagging one of the user profiles in the set of user profiles in response to receipt of a request to flag the user profile such that one or more communications associated with the user profile is sent to a compliance entity while the user profile is flagged.
